(19) United States
(12) Patent Application Publication
(10) Pub. No.: US 2026/0334479 A1
(43) Pub. Date: Oct. 29, 2026

(54) BAKED SNACK PRODUCT WITH ENHANCED TEXTURE

(71) Applicant: The Campbell’s Company, Camden, NJ (US)

(72) Inventors: Juan Yun, Ardmore, PA (US); Amanda Hope Thomason, Spring Grove, PA (US)

(21) Appl. No.: 19/641,201

(22) Filed: Apr. 7, 2026

Related U.S. Application Data
(60) Provisional application No. 63/785,367, filed on Apr. 8, 2025.

(51) Int. Cl. A21D 13/043; A21D 8/06; A21D 13/10; A21D 13/40; A23L 29/00; A23L 29/212; A23L 33/14

(52) U.S. Cl. CPC A21D 13/043; A21D 8/06; A21D 13/10; A21D 13/40; A23L 29/015; A23L 29/212; A23L 33/14

(57) ABSTRACT

Embodiments herein relate to baked snack products with enhanced texture and methods for making the same. In an embodiment, a baked snack food is included having a spherical outer crust and one or more nodules, wherein the one or more nodules extend outward from the spherical outer crust. The baked snack food also includes an inner portion, wherein the inner portion includes a plurality of cavities and is disposed inside of the spherical outer crust and the one or more nodules. The composition of the baked snack can include potato starch, corn starch, and a leavening system. The leavening system can include a yeast component, a sodium bicarbonate component, and ammonium bicarbonate. Other embodiments are also included herein.

This application claims the benefit of U.S. Provisional Application No. 63/785,367, filed Apr. 8, 2025, the content of which is herein incorporated by reference in its entirety.

### FIELD

Embodiments herein relate to baked snack products with enhanced texture and methods for making the same.

### BACKGROUND

The baked snack industry has been continuously evolving, driven by consumer demand for flavorful, convenient, and texturally intriguing products. Traditional baked snacks such as pretzels, chips, and crackers have been popular due to their variety of flavors and convenient consumption. Conventional production methods often involve frying or baking dough-based mixtures to create snacks.

### SUMMARY

Embodiments herein relate to baked snack products with enhanced texture and methods for making the same. In a first aspect, a baked snack food can be included having a spherical outer crust, one or more nodules, wherein the one or more nodules extend outward from the spherical outer crust, and an inner portion, wherein the inner portion includes a plurality of cavities and can be disposed inside of the spherical outer crust and the one or more nodules. The inner portion can include potato starch, corn starch, and a leavening system. The leavening system can include a yeast component, sodium bicarbonate, and ammonium bicarbonate.

In a second aspect, in addition to one or more of the preceding or following aspects, or in the alternative to some aspects, the leavening system lacks an acid component.

In a third aspect, in addition to one or more of the preceding or following aspects, or in the alternative to some aspects, the baked snack food can be baked at a temperature of 175 to 220 degrees Celsius.

In a fourth aspect, in addition to one or more of the preceding or following aspects, or in the alternative to some aspects, the one or more nodules can be formed by a lobe of extruded dough.

In a fifth aspect, in addition to one or more of the preceding or following aspects, or in the alternative to some aspects, the one or more nodules have a height to base diameter ratio ranging from 0.1 to 0.8.

In a sixth aspect, in addition to one or more of the preceding or following aspects, or in the alternative to some aspects, the leavening system evolves gas in three distinct time periods.

In a seventh aspect, in addition to one or more of the preceding or following aspects, or in the alternative to some aspects, the leavening system results in an expansion causing the inner portion to be at least 50% by volume air after baking.

In an eighth aspect, in addition to one or more of the preceding or following aspects, or in the alternative to some aspects, the leavening system results in an expansion causing the inner portion to be at least 70% by volume air after baking.

In a ninth aspect, in addition to one or more of the preceding or following aspects, or in the alternative to some aspects, wherein at least two nodules extend outward from the spherical outer crust.

In a tenth aspect, in addition to one or more of the preceding or following aspects, or in the alternative to some aspects, wherein at least three nodules extend outward from the spherical outer crust.

In an eleventh aspect, in addition to one or more of the preceding or following aspects, or in the alternative to some aspects, the inner portion further includes pretzel flour, salt, malt syrup, and a vegetable oil.

In a twelfth aspect, in addition to one or more of the preceding or following aspects, or in the alternative to some aspects, the baked snack food exhibits a crunchiness of greater than 10 peaks per millimeter (Mini Kramer).

In a thirteenth aspect, in addition to one or more of the preceding or following aspects, or in the alternative to some aspects, the baked snack food exhibits a crunchiness of 10 to 14 peaks per millimeter (Mini Kramer).

In a fourteenth aspect, in addition to one or more of the preceding or following aspects, or in the alternative to some aspects, the baked snack food exhibits a hardness of 12,000 to 18,000 grams (Mini Kramer).

In a fifteenth aspect, a method of making a baked snack product can be included. The method can include mixing a set of ingredients to form a dough. The set of ingredients can include a leavening system, the leavening system can include a yeast component, sodium bicarbonate, and ammonium bicarbonate. The method can further include extruding and cutting the dough to form discrete pieces including one or more lobes extending outward from a central portion and baking the discrete pieces, wherein baking the discrete pieces includes expanding the lobes to form nodules around a spherical central portion.

In a sixteenth aspect, in addition to one or more of the preceding or following aspects, or in the alternative to some aspects, the leavening system lacks an acid component.

In a seventeenth aspect, in addition to one or more of the preceding or following aspects, or in the alternative to some aspects, baking can be performed at a temperature of 175 to 220 degrees Celsius.

In an eighteenth aspect, in addition to one or more of the preceding or following aspects, or in the alternative to some aspects, the nodules have a height to base diameter ratio ranging from 0.1 to 0.8.

In a nineteenth aspect, in addition to one or more of the preceding or following aspects, or in the alternative to some aspects, the leavening system evolves gas in three distinct time periods.

In a twentieth aspect, in addition to one or more of the preceding or following aspects, or in the alternative to some aspects, the leavening system results in an expansion causing an inner portion of the baked snack to be at least 50% by volume air after baking.

In a twenty-first aspect, in addition to one or more of the preceding or following aspects, or in the alternative to some aspects, the leavening system results in an expansion causing an inner portion of the baked snack to be at least 70% by volume air after baking.

In a twenty-second aspect, in addition to one or more of the preceding or following aspects, or in the alternative to some aspects, the discrete pieces of extruded dough include at least two lobes.

In a twenty-third aspect, in addition to one or more of the preceding or following aspects, or in the alternative to some aspects, the discrete pieces of extruded dough include at least three lobes.

In a twenty-fourth aspect, in addition to one or more of the preceding or following aspects, or in the alternative to some aspects, the set of ingredients can further include potato starch, corn starch, pretzel flour, malt syrup, and a vegetable oil.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of a baked snack product in accordance with various embodiments herein.

FIG. 2 is a schematic cross-sectional view of a baked snack product in accordance with various embodiments herein.

FIG. 3 is a schematic view of an extruded piece of dough in accordance with various embodiments herein.

FIG. 4 is a flowchart illustrating operations of a method in accordance with various embodiments herein.

FIG. 5 is a chart showing a comparison of measured hardness of baked snack products herein versus other products in accordance with various embodiments herein.

FIG. 6 is a chart showing a comparison of measured crunchiness of baked snack products herein versus other products in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

The present invention relates to baked snack products characterized by an enhanced texture and shape, achieved through a novel combination of ingredients and a unique processing method. Methods herein of forming a baked snack result in one that is not only texturally and visually distinct but also enhanced in desirable functional properties. For example, by utilizing a specific combination of starches, a distinct three-phase leavening system, and an extrusion technique with unique lobes, the resulting snack product exhibits improved sensory properties while also maintaining structural integrity.

Embodiments of baked snack products herein can include a substantially spherical outer crust and one or more nodules extending therefrom, with an interior characterized by a network of pockets or cavities. The integration of potato starch, corn starch, and pretzel flour into the dough composition, along with a three-phase leavening system including a yeast component, ammonium bicarbonate, and sodium bicarbonate, facilitates the formation of an inner portion that can achieve up to 50, 60, 70, 80, or 90 % or more by volume air post-baking (or an amount falling within a range between any of the foregoing). In various embodiments, the leavening system operates without an acid component, providing a controlled rise and expansion during the baking process, resulting in a desirably airy texture. In addition, the leavening system operates during three distinct phases, which creates unique structural characteristics of the baked snack product contributing to desirable textural characteristics thereof.

A significant benefit of embodiments herein is their distinctive textural properties and shape of the finished snack product. The dough yields an outer crust that is sufficiently firm to support the nodules while also ensuring a crisp exterior. The nodules themselves, formed by expanding lobes of the extruded dough, contribute to the visual appeal and provide bite-size protrusions that enhance the snack's crunchiness as they can be separately collapsed during the chewing process. The leavening system herein also optimizes the porosity and lightness of the inner portion without compromising the snack's structural integrity which is important so that there is less fragmentation and waste during handling and transportation and fewer broken crumbs left in the package at the time of consumption.

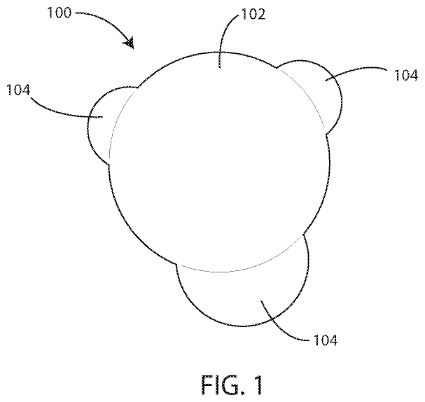

Referring now to FIG. 1, an exemplary baked snack product 100 is depicted. This snack 100 features a distinctive design with a central main portion 102 that is substantially spherical. The crust of the spherical portion forms the outer structure, establishing the fundamental shape of the product. Extending from this spherical main portion are several nodules 104, which enhance both the texture and visual appeal of the snack. These nodules effectively contribute to its complex shape, creating a unique three-dimensional structure. In addition, the nodules 104 can be collapsed (broken down) separately from the main spherical portion (such as sequentially) during the chewing process which enhances the perception of crunchiness.

The nodules 104 can be formed from lobes which are made during the process of extruding the dough. This method of formation allows the nodules to exhibit a varied height to base diameter ratio ranging from 0.1 to 0.8, adding to the textural diversity of the snack. In some embodiments, each piece of the snack product includes at least two different sized nodes in terms of height, width, or both. In some embodiments, each piece of the snack product includes at least three different sized nodes in terms of height, width, or both. In some embodiments, each piece of the snack product includes at least four different sized nodes in terms of height, width, or both. The drawing specifically illustrates at least three nodules extending outward, illustrating multiple protrusions which stand proud of the overall spherical crust. The overall volume of the nodules can vary depending on factors such as the number of nodules included and/or their size. However, in various embodiments, the volume of the nodules can be at least about 2, 5, 10, 15, 20, 25, or even 30 percent by volume of the overall baked snack product. In some embodiments, the volume can fall within a range between any of the foregoing.

Internally, the snack product includes an inner portion characterized by a network of interconnected air pockets, or pores. The size and distribution of these pockets is specifically influenced by the unique three-phase leavening system herein. In particular, the leavening system is designed to generate gas during three distinct periods, thereby influencing the expansion kinetics of the dough matrix. The initial phase of gas evolution can be generated by a yeast component and can result in the nucleation and growth of primary air cells, establishing a foundation of relatively smaller pores. This first phase begins before the baking process while the dough is still in a completely prebaked state characterized by higher cohesiveness and elasticity.

The second phase can be generated by an ammonium bicarbonate component. The ammonium bicarbonate can begin to break down and evolve gas after the baking process of the dough begins and a temperature of at least about 36 degrees Celsius has been reached. During the second phase, further gas production contributes to the expansion of the initial air cells, promoting an increase in pore size and interconnectedness. This phase plays a pivotal role in defining the intermediate pore architecture and dispersion throughout the dough matrix.

The third phase can be generated by a sodium bicarbonate component. The sodium bicarbonate can begin to break down and evolve gas after the temperature of the dough has reached at least about 80 degrees Celsius. In the third phase, a final surge of gas evolution occurs at this elevated temperature threshold, leading to the expansion of pre-existing cavities and facilitating the formation of new air pockets within any densely packed areas. However, as the dough is already partially baked at this point, there is generally less elasticity and some of the existing pockets rupture interconnecting them with adjacent cavities or pockets. However, by this time the surface has already gained significant structural integrity and so the surface is not ruptured at this point of the process. This multilayered gas release mechanism not only contributes to a specific distribution of air pockets but also drives the transformation of the dough structure into a unique crumb. Thus, through these distinct leavening phases, the resultant baked snack product achieves a consistent and desirable porosity, contributing substantially to its airy texture and structural integrity post-baking.

The amount of ammonium bicarbonate can vary. In some embodiments, the amount of ammonium bicarbonate can be from 0.1 wt. % to 4 wt. %, or from 0.3 wt. % to 2 wt. %. The amount of sodium bicarbonate can vary. In some embodiments, the amount of sodium bicarbonate can be from 0.05 wt. % to 3 wt. %, or from 0.1 wt. % to 1.5 wt. %. The amount of yeast can be at least about 0.1, 0.5, 1, 2, 3, 4, or 5 wt. % or an amount falling within a range between any of the foregoing.

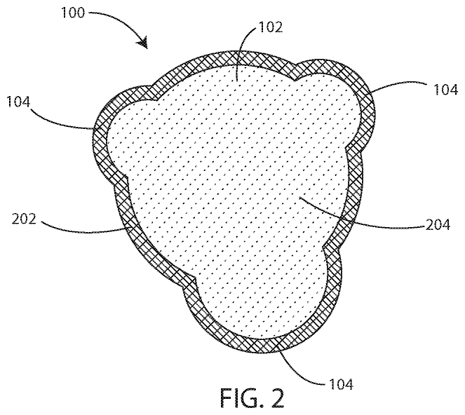

FIG. 2 illustrates a cross-section of a baked snack product 100. The primary structure of this snack is defined by a circular main portion 102, which forms the central body of the product. Surrounding this central portion is the outer crust, denoted by reference number 202. This crust provides the snack with its resilient structure and supports the complex shape created by the extensions from the body.

Extending from the circular main portion are nodules 104. These nodules enhance both the tactile and visual properties of the snack, contributing to its unique three-dimensionality. The nodules are formed through the extrusion of dough lobes and display a ratio of height to base diameter ranging between 0.1, 0.2, 0.3, 0.4, 0.5, 0.6, 0.7 and 0.8, or a ration falling within a range between any of the foregoing according to various embodiments herein. This configuration ensures that the snack maintains a highly crunchy texture upon consumption as the nodules can collapse separately during chewing adding to the crunchy sensation. In various embodiments, snacks herein can have a crunchiness value of greater than 10, 11, 12, 13, 14 or more peaks in the force curve per millimeter of blade travel (or an amount falling within a range between any of the foregoing) as measured using a Mini Kramer shear cell as further described in the examples herein. The hardness of snacks herein can be from 12,000 to 18,000 grams, or from 14,000 to 16,000 grams, also as measured using a Mini Kramer shear cell.

The inner portion of this snack product is characterized by the area designated as 204. This inner portion is formed as the dough expands. The dough can be formulated with potato starch, corn starch, and pretzel flour, further enriched by salt, malt syrup, and vegetable oil. The amount of potato starch can be at least about 5, 10, 15, 20, 25, 30, or 40 wt. % or an amount falling within a range between any of the foregoing. The amount of corn starch can be at least about 5, 10, 15, 20, 25, 30, or 40 wt. % or an amount falling within a range between any of the foregoing. The amount of pretzel flour can be at least about 5, 10, 15, 20, 25, 30, or 40 wt. % or an amount falling within a range between any of the foregoing. The amount of salt can be about 0.5, 1, 2, 3, 4,5, or 7.5 wt. % or an amount falling within a range between any of the foregoing. The amount of malt syrup can be about 0.5, 1, 2, 3, 4, 5, 7.5, or 10 wt. % or an amount falling within a range between any of the foregoing. The amount of vegetable oil can be about 2, 5, 7.5, 10, or 15 wt. % or an amount falling within a range between any of the foregoing.

The leavening system used lacks an acid component and evolves gas in three distinct phases to ensure a calculated expansion during baking. This results in the inner portion with a high volume of air, creating an exceptionally airy, light composition while retaining the structural integrity needed for handling and consumption.

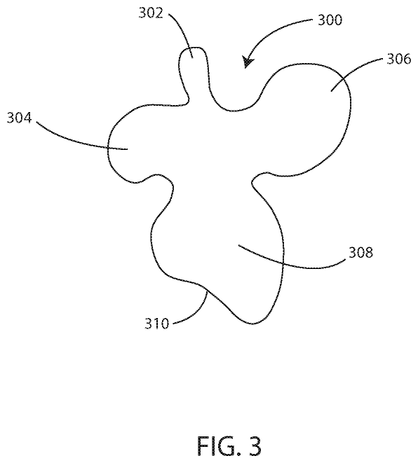

As referenced elsewhere herein, the dough can be extruded into a shape including a plurality of lobes. FIG. 3 provides a detailed depiction of an extruded dough piece 300. This extruded dough piece 300 is integral to the formation of the baked snack product's unique structure. The extruded dough piece 300 includes multiple lobes that extend outward in various directions, contributing to the snack's distinctive textural complexity and shape retention during and after baking.

The first lobe 302 undergoes multidirectional expansion during the process of making the snack, establishing a key aspect of the snack's signature shape and texture. Adjacent to the first, the second lobe 304, complements the configuration, enhancing the overall shape and texture. Continuing the sequence, the third lobe 306 also projects from the central portion of the extruded dough piece along with the fourth lobe 308. In various embodiments, a concave area 310 serves as a focus zone for expanding as the dough undergoes baking, allowing the entire piece to adjust and stabilize. In some embodiments, it can act as a foundational component that supports the largest lobe.

Extrusion of the dough can be carried out in various ways. In some embodiments, the extrusion process is implemented using a specifically designed extrusion apparatus that includes an extrusion head and/or extrusion die configured to form dough into multiple interconnected lobes while maintaining the desired moisture content and consistency. The extrusion apparatus can include a single-screw or twin-screw configuration, depending on the rheological properties of the dough and the required processing conditions. In some embodiments, the extrusion head can be equipped with multiple nozzles or die openings, arranged to guide the dough into lobular formations as it exits the machine. The die openings can be adjusted in diameter and spacing to control the size and shape of the lobes, ensuring that each nodule extends outward from the spherical central portion.

Upon being extruded, the dough moves through a cutting mechanism, where a rotating knife or guillotine knife cuts it into discrete pieces, each possessing one or more protruding lobes. These lobes are configured to promote expansion during the baking process, forming nodules that contribute to the snack's unique texture and aesthetic appeal. The cutting speed and blade sharpness can be adjusted to prevent the formation of jagged edges, thereby enhancing the structural integrity of the extruded dough pieces.

After cutting, the extruded dough pieces are transferred onto a conveyor system leading into a baking tunnel. The placement of the pieces on the conveyor can be controlled as overlap or misalignment can affect the uniformity of heat distribution, potentially leading to inconsistent puffing of the lobes. The baking tunnel can be equipped with multiple heating zones to facilitate a gradual increase in temperature, promoting even expansion and a desirable crust texture. Specific airflow controls can be utilized to ensure that the hot air circulates efficiently around and between the dough pieces, optimizing the baking process for attaining the desired textural properties.

Throughout the extrusion and baking phases, various monitoring sensors, such as moisture sensors and infrared thermometers, can be utilized to provide real-time data on the dough's moisture content and temperature, allowing for adjustments to be made in the processing conditions to maintain product quality. In some instances, the extrusion apparatus and baking tunnel are integrated into an automated system that can regulate operational parameters through a centralized control unit, ensuring consistency in production while reducing the need for manual intervention.

Precise control over the extrusion and baking processes enables the creation of baked snacks with a high air volume in the inner portion, enhancing the sensory properties and consumer appeal of the product.

In various embodiments, seasonings, spices, and/or flavoring agents can be deposited onto the baked snack. The application of such components onto the baked snack product can impart diverse flavors, enhancing consumer appeal and broadening potential marketability. Various embodiments involve the use of flavoring agents such as cheese powder, onion powder, and garlic powder, which can be evenly distributed across the snack's surface through a tumbling process post-baking. The tumbling process ensures uniform coating, whereby baked snacks are introduced into a rotating drum equipped with sprayers or nozzles that dispense a measured amount of seasoning as the snacks pass through. The rotation facilitates the rolling of snacks, allowing complete seasoning coverage while minimizing excess application and wastage.

In another embodiment, the introduction of an oil and seasonings slurry is utilized to improve adhesion of seasoning, spices, and/or flavoring agents such as chili powder, paprika, and cumin onto the snack surface. This technique involves initially coating the snacks with a thin layer of vegetable oil, followed by the application of powdered components. The oil acts as an adherence medium that secures the powdered spices to the snack's exterior. In some embodiments, the incorporation of sweet flavor profiles such as cinnamon-sugar or honey-butter is achieved through a similar slurry application method, where granulated sweeteners or powdered extracts are dissolved or suspended in a minimal amount of oil or melted butter before being applied.

In some embodiments, enhancements in processing techniques allow for the application of exotic and gourmet flavors such as truffle salt and smoked sea salt, such as being added via a precision electrostatic coating system. In this approach, a system can generate an electrostatic charge to the selected seasoning, facilitating even distribution as the charge allows the seasoning particles to cling closely to the neutral-charge snack surface, promoting efficient and concentrated flavor application.

In some embodiments, the seasoning process may include a final baking step intended to dry and set the applied flavors. This final baking stage is conducted at a lower temperature range, allowing the seasonings to integrate more thoroughly with the outer crust without significantly altering the internal textural dynamics of the snack. Such processing not only enriches the snack with a robust flavor profile but also aids in maintaining the original crisp texture post-seasoning application.

### Methods

Many different methods are contemplated herein, including, but not limited to, methods of making, methods of using, and the like. Aspects of manufacturing/baking system operation described elsewhere herein can be performed as operations of one or more methods in accordance with various embodiments herein.

In an embodiment, a method of making a baked snack product is included, the method can include mixing a set of ingredients to form a dough. The set of ingredients can specifically include a leavening system. The leavening system can include a yeast component, ammonium bicarbonate, and sodium bicarbonate. The method can also include extruding and cutting the dough to form discrete pieces including one or more lobes extending outward from a central portion. The method can also include baking the discrete pieces, wherein baking the discrete pieces includes expanding the lobes to form nodules around a spherical central portion.

In particular embodiments, the method for producing the baked snack product involves the absence of an acid component within the leavening system. This unique leavening configuration is designed to foster a specific profile of dough expansion that benefits the structural and textural properties of the final product. By deliberately excluding the acid component, the leavening system relies on the yeast component, ammonium bicarbonate, and sodium bicarbonate as the primary agents of gas evolution. In addition, by excluding an acid component, the evolution of gas by the sodium bicarbonate component is delayed such that there are three distinct phases of gas evolution instead of it all occurring simultaneously.

The baking process is generally carried out at temperatures ranging from 175 degrees Celsius to 220 degrees Celsius. This temperature range is generally optimal for facilitating the dough expansion and crisping of the outer crust without compromising the inner matrix's aerated structure. Baking within these parameters ensures the lobes of extruded dough expand consistently, forming a well-defined nodule structure around the central spherical portion of the snack.

Regarding the structural characteristics imparted during the extrusion and baking processes, the nodules generally possess a height to base diameter ratio between 0.1 to 0.8. This dimensional attribute contributes significantly to the snack's textural identity, offering a distinctive combination of crisp exterior and an airy internal structure. The specified height to base diameter ratio ensures that the nodules maintain structural integrity and provide a crunchy texture that enhances the consumer's sensory experience.

As described above, the leavening system within the dough evolves gas in three distinct time periods, which contributes to the thorough aeration and lightness of the inner portion of the snack. Initially, gas production initiates during dough preparation and initial thermal exposure, followed by intermediate and final phases that coincide with specific temperature milestones during baking. This phased gas evolution promotes systematic expansion and results in a unique distribution of air pockets.

During extrusion, the dough is formed into discrete pieces characterized by multiple lobes that protrude from a central structural portion. Each discrete piece can possess at least two lobes, and in alternative embodiments, at least three lobes. These lobes are critical in forming the nodules during baking, with each lobe expanding to create the protrusions that define the product's unique shape and texture. The multi-lobed design contributes to the snack's visual appeal and provides a textural complexity that distinguishes it from conventional baked goods.

Finally, the composition of the dough, in this method, can integrate ingredients such as potato starch, corn starch, pretzel flour, malt syrup, and a vegetable oil. The inclusion of these components not only enhances the dough's workability during extrusion but also augments the flavor profile and contributes to the desirable textural attributes of the final product. The selection of these ingredients ensures that the dough's properties are optimized for both the extrusion process and baking dynamics, resulting in a baked snack that meets the desired quality and sensory standards.

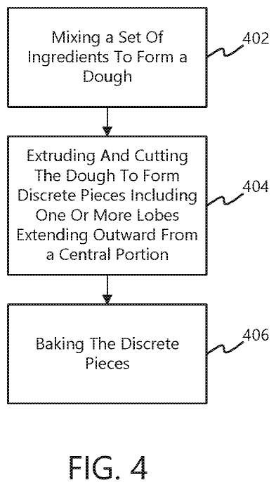

The drawing illustrated in FIG. 4 provides a flowchart outlining a method for creating a baked snack product with enhanced texture. The process begins with the mixing operation, denoted as 402. In this step, a set of ingredients is combined to form a dough. This mixture includes a specialized leavening system comprising a yeast component, ammonium bicarbonate, and sodium bicarbonate. These components work together to facilitate the dough's rise and expansion during subsequent processing stages.

Following the dough preparation, the method proceeds to the extruding and cutting operation, labeled 404. Here, the dough is extruded and cut into discrete pieces, each designed to include one or more lobes extending outward from a central portion. his shaping process is crucial as the lobes will later expand during baking to form nodules, contributing to the snack's distinctive structure and texture.

The final stage, identified as the baking operation 406, involves baking the discrete pieces. This step achieves the final desired expansion and texture. During baking, the lobes expand, forming nodules around a spherical central portion. This results in the creation of a snack product that is not only visually appealing but also offers a unique texture with its combination of a firm outer crust and airy interior.

Aspects may be better understood with reference to the following examples. These examples are intended to be representative of specific embodiments, but are not intended as limiting the overall scope of embodiments herein.

### EXAMPLES

### Example 1: Texture Analysis of Baked Snacks

Texture analysis of three different types of baked snacks was assessed using a Button Test as performed with a Mini Kramer device (a shear-compression cell device 30 mm stroke with walls removed from the cell). In specific, product samples (a test product formulated and prepared as described herein, a first comparison product (“CRISP BITES”—exhibiting a flat pretzel shape), and a second comparison product (“ROUNDS”—exhibiting a round shape) were placed in the cell of the Mini Kramer device where the blades apply a consistent compression force until the samples break or reach a specific texture threshold. The data collected include data reflecting hardness (the maximum force needed to compress and break the samples, indicating how firm they are) and crunchiness (measured as the number of force peaks per mm, indicating how many and how intense the crunches are during the test).

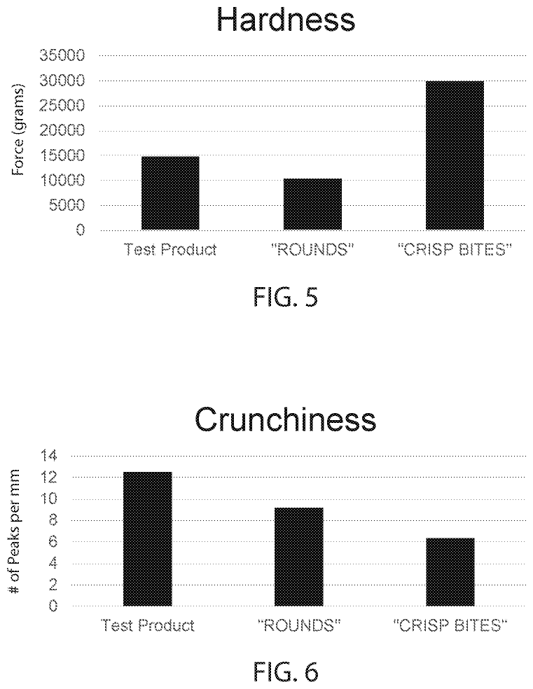

The data are shown in FIGS. 5 and 6. The data show that product samples consistent with embodiments herein have a distinct texture profile compared to the other baked products tested. In specific, the baked snack products herein are higher in crunchiness (approximately 25 percent higher than the second comparison product (“ROUNDS”) and 50 percent more than the first comparison product (“CRISP BITES”). For hardness, the first comparison product was two times harder than the baked snack products herein and three times harder than the second comparison product. These results indicate the baked snack products herein exhibit texture parameters that are unique among the different shapes and types of snack products tested. The baked snack products herein are not as hard as the flat type of pretzel, are slightly harder than their round counterpart, but significantly crunchier than both other tested products.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A baked snack food comprising:
a spherical outer crust;
one or more nodules, wherein the one or more nodules extend outward from the spherical outer crust; and
an inner portion, wherein the inner portion includes a plurality of cavities and is disposed inside of the spherical outer crust and the one or more nodules, the inner portion comprising
potato starch;
corn starch; and
a leavening system, the leavening system comprising
a yeast component;
sodium bicarbonate; and
ammonium bicarbonate.

2. The baked snack food of claim 1, wherein the leavening system lacks an acid component.

3. The baked snack food of claim 1, wherein the baked snack food is baked at a temperature of 175 to 220 degrees Celsius.

4. The baked snack food of claim 1, wherein the one or more nodules are formed by a lobe of extruded dough.

5. The baked snack food of claim 1, wherein the one or more nodules have a height to base diameter ratio ranging from 0.1 to 0.8.

6. The baked snack food of claim 1, wherein the leavening system evolves gas in three distinct time periods.

7. The baked snack food of claim 1, wherein the leavening system results in an expansion causing the inner portion to be at least 50% by volume air after baking.

8. The baked snack food of claim 1, wherein the leavening system results in an expansion causing the inner portion to be at least 70% by volume air after baking.

9. The baked snack food of claim 1, wherein at least two nodules extend outward from the spherical outer crust.

10. The baked snack food of claim 1, wherein at least three nodules extend outward from the spherical outer crust.

11. The baked snack food of claim 1, wherein the inner portion further includes pretzel flour, salt, malt syrup, and a vegetable oil.

12. The baked snack food of claim 1, wherein the baked snack food exhibits a crunchiness of greater than 10 peaks per millimeter (Mini Kramer).

13. The baked snack food of claim 1, wherein the baked snack food exhibits a crunchiness of 10 to 14 peaks per millimeter (Mini Kramer).

14. The baked snack food of claim 1, wherein the baked snack food exhibits a hardness of 12,000 to 18,000 grams (Mini Kramer).

15. A method of making a baked snack product comprising:
mixing a set of ingredients to form a dough, the set of ingredients comprising
a leavening system, the leavening system comprising
a yeast component;
sodium bicarbonate; and
ammonium bicarbonate;
extruding and cutting the dough to form discrete pieces including one or more lobes extending outward from a central portion; and
baking the discrete pieces, wherein baking the discrete pieces includes expanding the lobes to form nodules around a spherical central portion.

16. The method of making a baked snack product of claim 15, wherein the leavening system lacks an acid component.

17. The method of making a baked snack product of claim 15, wherein baking is performed at a temperature of 175 to 220 degrees Celsius.

18. The method of making a baked snack product of claim 15, wherein the nodules have a height to base diameter ratio ranging from 0.1 to 0.8.

19. The method of making a baked snack product of claim 15, wherein the leavening system evolves gas in three distinct time periods.

20. The method of making a baked snack product of claim 15, wherein the leavening system results in an expansion causing an inner portion of the baked snack to be at least 50% by volume air after baking.

21-24. (canceled)
